(19) United States
(12) Patent Application Publication
(10) Pub. No.: US 2009/0061219 A1
(43) Pub. Date: Mar. 5, 2009

(54) Composition for Coating Glass

(75) Inventors: Rachael Spynda, Wexford, PA (US); Robert M. O'Brien, Monongahela, PA (US); Bobbie List, McKeesport, PA (US); Rick Boswell, Washington, PA (US)

Correspondence Address: VALSPAR SOURCING, INC., 1101 SOUTH THIRD STREET, MINNEAPOLIS, MN, 55415, US

(73) Assignee: VALSPAR SOURCING, INC., Minneapolis, MN (US)

(21) Appl. No.: 12/186,249

(22) Filed: Aug. 5, 2008

Related U.S. Application Data
(60) Provisional application No. 60/968,459, filed on Aug. 28, 2007.

(51) Int. Cl. C09D 11/02; B05D 3/02; B32B 5/00

(52) U.S. Cl. 428/337; 523/160; 427/385.5

(57) ABSTRACT

A coating composition is provided that is suitable for use on glass articles. When suitably cured on a glass substrate, the coating composition provides a durable and abrasion resistant coating. The coating composition preferably includes an acrylic polymer, an optional crosslinker, and a carrier.

### CROSS REFERENCE TO RELATED APPLICATION

This application claims priority to Provisional Application Ser. No. 60/968,459 filed on Aug. 28, 2007, entitled “Composition for Coating Glass,” which is incorporated herein by reference in its entirety.

### TECHNICAL FIELD

This invention relates to durable polymer coating compositions. More specifically, this invention relates to durable polymer coating compositions useful for coating a wide variety of articles, including glass articles such as beer and beverage containers.

### BACKGROUND

Conventional colored glass articles are formed using pigmented materials that are incorporated into the raw materials prior to glass formation. Conventional colored glass production has several drawbacks. First, switching from one color of glass production to another typically requires shutting down the glass melting furnace and cleaning the furnace before another color of glass can be produced, which results in costly lost production time. Due to the costs associated with changing glass color production, the glassmaking industry typically minimizes the occurrence of such changeovers by stockpiling inventory, which results in undesirable inventory costs. Moreover, conventional colored glass batches tend to exhibit corrosive properties that can reduce the life of melting furnaces.

To address the shortcomings associated with conventional production of colored glass, attempts have been made in the glassmaking industry to develop colored coatings that can be applied to glass articles after formation. Such coatings are desirable because a single type of glass could be produced and then post-colored through application of a colored coating, thereby reducing production and inventory costs and extending furnace life. To date, however, a colored coating is not commercially available that exhibits a suitable blend of properties such as, for example, recyclability, abrasion resistance (especially in high-throughput production lines common in beer and beverage container production and bottling), adhesion, pasteurization, resistance, pot-life, and suitable aesthetics. As such, the glassmaking industry continues to directly pigment glass batches for use in demanding end uses such as, for example, beer and beverage bottling.

What is needed in the marketplace is an improved coating system for coloring glass articles that exhibits a suitable balance of desired properties.

### SUMMARY

In formulating a polymer coating for use in coating glass articles, the challenge for the coating designer is to balance a variety of coating characteristics such as aesthetics, recyclability, adhesion, abrasion resistance, pasteurization resistance, stability and cost.

In one aspect, the invention provides a coating composition that exhibits excellent abrasion resistance. In preferred embodiments, the coating composition, when cured on a flat glass substrate, exhibits a taber abrasion resistance of at least about 100 cycles when tested pursuant to ASTM D4060-01 as described herein.

In another aspect, the invention provides a coating composition that includes a resin system having an acrylic polymer and preferably one or more of a crosslinker, a silane coupling agent, and an aqueous carrier. In one embodiment, the resin system includes an acrylic polymer having a T_{g} of at least about 30° C. In a presently preferred embodiment, the resin system is a reaction product of an oxirane-functional vinyl addition polymer, an acid-functional polymer, and a tertiary amine.

In another aspect, the invention provides a coated article that includes a glass substrate having an adherent coating composition described herein applied to at least a portion of the glass substrate. In some embodiments, the coating composition includes a colorant or other additive to yield a coated article exhibiting a desired color or aesthetic property.

In another aspect, the invention provides a coated article that includes a glass substrate such as, for example, a coated beer or soda container. A coating composition is applied over at least a portion of the glass substrate. The coating composition preferably includes a water-dispersible acrylic resin system, a crosslinker, and an aqueous carrier. In a preferred embodiment, the water-dispersible acrylic resin system is a reaction product of (i) an oxirane-functional vinyl addition polymer having an oxirane functionality of 0.5 to 5, (ii) an acid-functional polymer having an acid number of 30 to 500, and (iii) a tertiary amine.

In yet another aspect, the invention provides a method for forming a coated article. A coating composition described herein and a glass substrate are provided. The coating composition is applied to at least a portion of the glass substrate. The coating composition is cured to produce a cured coating composition that preferably exhibits a taber abrasion resistance of at least about 100 cycles when tested pursuant to ASTM D4060-01 as described herein.

The above summary of the invention is not intended to describe each disclosed embodiment or every implementation of the invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the description below. Other features, objects, and advantages of the invention will be apparent from the description and from the claims.

### DEFINITIONS

Unless otherwise specified, the following terms as used herein have the meanings provided below.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group or an aromatic group, both of which can include heteroatoms. The term “alicyclic group” means a cyclic hydrocarbon group having properties resembling those of aliphatic groups. The term “Ar” refers to a divalent aryl group (i.e., an arylene group), which refers to a closed aromatic ring or ring system such as phenylene, naphthylene, biphenylene, fluorenylene, and indenyl, as well as heteroarylene groups (i.e., a closed ring hydrocarbon in which one or more of the atoms in the ring is an element other than carbon (e.g., nitrogen, oxygen, sulfur, etc.)). Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “heteroarylene” groups (e.g., furylene, pyridylene, etc.).

A group that may be the same or different is referred to as being “independently” something. Substitution is anticipated on the organic groups of the compounds of the present invention. As a means of simplifying the discussion and recitation of certain tenninology used throughout this application, the tenns “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

Unless otherwise indicated, a reference to a “(meth)acrylate” compound (where “meth” is bracketed) is meant to include both acrylate and methacrylate compounds.

The terms “vinyl addition polymer” or “vinyl addition copolymer” is meant to include acrylate, methacrylate, and vinyl polymers and copolymers.

The term “dispersible” in the context of a dispersible polymer means that the polymer can be mixed into a carrier to form a macroscopically uniform mixture without the use of high shear mixing. The term “dispersible” is intended to include the term “soluble.” In other words, a soluble polymer is also a dispersible polymer.

The term “water-dispersible” in the context of a water-dispersible polymer means that the polymer can be mixed into water to form a macroscopically uniform mixture without the use of high shear mixing. The term “water-dispersible” is intended to include the term “water-soluble.” In other words, a water-soluble polymer is also considered to be a water-dispersible polymer.

The term “dispersion” in the context of a dispersible polymer refers to the mixture of a dispersible polymer and a carrier. The term “dispersion” is intended to include the term “solution.”

The term “crosslinker” refers to a molecule capable of forming a covalent linkage between polymers or between two different regions of the same polymer.

Unless otherwise indicated, a reference to a “polymer” is also meant to include a copolymer (i.e., polymers of two or more different monomers).

The terms “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” amine can be interpreted to mean that the coating composition includes “one or more” amines.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In one aspect, the invention provides a coating composition suitable for forming an adherent coating on a glass substrate. Preferred coating compositions, when cured on a glass substrate, provide a durable coating that exhibits excellent abrasion resistance, pasteurization resistance, and aesthetics. The coating composition, when applied to a clear glass substrate and including an optional colorant, is capable of producing a colored article having aesthetic properties similar to that of a conventional article produced from colored glass. In preferred embodiments, the coating composition is capable of passing at least one (and preferably both) of the Tabor Abrasion and Pasteurization Tests described below in the Test Methods section.

Preferred coating compositions include a resin system, an optional crosslinker, and a carrier. Preferably, the coating composition is an aqueous dispersion of a water-dispersible resin system. Although the resin system may include any suitable combination of one or more polymers, the resin system preferably includes at least one acrylic polymer. The acrylic polymer may be formed exclusively from acrylic compounds or, alternatively, from a suitable combination of acrylic and non-acrylic compounds.

Acrylic polymers tend to yield cured coatings that are hard but not tough, with the coatings tending to be brittle and glassy. Not surprisingly, coatings rich in acrylic polymer are typically susceptible to damage by abrasion. This is especially true for acrylic coatings subjected to the demanding conditions associated with high-speed production lines, where the coatings typically come into repeated contact (e.g., through striking, rubbing, scraping, etc.) with other coated articles as well as production equipment. For example, the abrasive forces associated with beer bottle production and bottling lines can be particularly severe. Given the poor abrasion resistance typically associated with acrylic coatings, it was a surprising and unexpected result that preferred acrylic coating compositions of the invention exhibited excellent abrasion resistance. In particular, it was a surprising and unexpected result that preferred acrylic coating compositions of the invention exhibited particularly high levels of abrasion resistance when tested using the rigorous Abrasion Resistance Tests described below in the Test Methods section, which are intended to model the abrasive forces associated with high-speed beer and bottling lines.

Preferably, the resin system includes at least one acrylic polymer having a glass transition temperature (“T_{g}”) of at least about 30° C., more preferably at least about 60° C. Preferably, the T_{g} of the acrylic polymer is less than about 120° C., more preferably less than about 90° C. In a presently preferred embodiment, the T_{g} of the acrylic polymer is between about 60° C. and about 90° C. In general, the Fox equation may be employed to calculate the theoretical T_{g} of acrylic portions of a polymer resulting from reaction of the acrylic compounds. As used herein, unless otherwise specified, T_{g} refers to a theoretical T_{g} calculated using an equation such as, for example, the Fox equation. While not intending to be bound by theory, it is believed that the T_{g} of acrylic portions of the acrylic polymer is one factor in achieving suitable abrasion resistance. While not intending to be bound by any theory, acrylic polymers having unsuitably low T_{g}'s generally produce excessively soft or tacky films, which tend to display poor abrasion resistance when contacted by similar films and dissimilar packing materials, while acrylic polymers having unsuitably high T_{g}'s generally produce excessively brittle films that are highly susceptible to impact fracture.

Any suitable amount of one or more acrylic polymers can be included in coating compositions of the invention. Preferably, the coating compositions include an amount of acrylic polymer that constitutes at least about 30% by weight, more preferably 40% by weight, and even more preferably 50% by weight of the coating composition, based on the total nonvolatile weight of the coating composition. In some embodiments, the amount of acrylic polymer may constitute up to about 80% or more of the total nonvolatile weight of the coating composition. If desired, the resin system may include one or more non-acrylic polymers so long as the properties of the coating, when cured, are not unsuitably degraded.

The amount of acrylic compound present in the acrylic polymer may vary depending upon the desired properties. Examples of acrylic compounds include (meth)acrylate compounds (e.g., including those described below), vinyl compounds (e.g., vinyl acetate, styrene, etc. (Sections 045 and 046 Examples Sufficient)), and mixtures thereof. In preferred embodiments, the acrylic polymer includes at least about 15, more preferably at least about 25, and even more preferably at least about 40 weight percent (“wt-%”) of acrylic compound, based on the total nonvolatile weight of reactants used to from the acrylic polymer (which will typically be approximately the nonvolatile weight of the polymer). In some embodiments, the acrylic compound may constitute up to about 100% of the nonvolatile weight of the acrylic polymer.

(Meth)acrylate compounds are preferred acrylic compounds. In a presently preferred embodiment, the acrylic polymer is a reaction product of reactants including at least some glycidyl (meth)acrylate. Examples of suitable (meth)acrylate compounds include any of those described below.

The resin system, including the acrylic polymer, is preferably heat-curable, whereby any suitable curing temperature can be employed to affect curing. Although not presently preferred, if desired, the resin system can be curable by any other suitable means such as, for example, radiation (e.g., UV) cure.

In a presently preferred embodiment, the resin system includes a water-dispersible polymer having reacted oxirane and acid groups, which is preferably an acrylic polymer. Examples of such polymers are taught in U.S. Pat. No. 7,189,787 entitled Aqueous Dispersions and Coatings, which is incorporated herein by reference in its entirety. While not intending to be bound by any theory, in certain embodiments, the inclusion of a suitable amount of such polymer(s) in coating compositions is believed to contribute to the excellent abrasion resistance for cured coatings resulting therefrom.

In part, U.S. Pat. No.7,189,787 describes certain polymers that are the reaction product of (i) an oxirane-functional vinyl addition polymer, (ii) an acid-functional polymer, and (iii) a tertiary amine. Preferably, the polymers are a reaction product of (i) an oxirane-functional vinyl addition polymer having an oxirane functionality of 0.5 to 5 (more preferably 0.9 to 3), (ii) an acid-functional polymer having an acid number (“AN”) of 30 to 500 (more preferably 100 to 400), and (iii) a tertiary amine. Further discussion of such polymers is provided below. In certain preferred embodiments, at least one, and more preferably both, of the oxirane-functional vinyl addition polymer and acid-functional polymer are acrylic polymers, and more preferably acrylic polymers having a T_{g} of at least about 30° C.

Suitable oxirane-functional monomers for inclusion in the oxirane-functional vinyl addition polymer include monomers having a reactive carbon-carbon double bond and an oxirane (i.e., a glycidyl) group. Typically, the monomer is a glycidyl ester of an alpha, beta-unsaturated acid, or anhydride thereof. Suitable alpha, beta-unsaturated acids include monocarboxylic acids or dicarboxylic acids. Examples of such carboxylic acids include, but are not limited to, acrylic acid, methacrylic acid, alpha-chloroacrylic acid, alpha-cyanoacrylic acid, beta-methylacrylic acid (crotonic acid), alpha-phenylacrylic acid, beta-acryloxypropionic acid, sorbic acid, alpha-chlorosorbic acid, angelic acid, cinnamic acid, p-chlorocinnamic acid, beta-stearylacrylic acid, itaconic acid, citraconic acid, mesaconic acid, glutaconic acid, aconitic acid, maleic acid, fumaric acid, tricarboxyethylene, maleic anhydride, and mixtures thereof.

Specific examples of suitable monomers containing a glycidyl group are glycidyl (meth)acrylate (i.e., glycidyl methacrylate and glycidyl acrylate), mono- and di-glycidyl itaconate, mono- and di-glycidyl maleate, mono- and di-glycidyl formate, and mixtures thereof. It is also envisioned that allyl glycidyl ether and vinyl glycidyl ether can be used as the oxirane-functional monomer. A preferred monomer is glycidyl methacrylate (“GMA”).

It also should be pointed out that the oxirane-functional vinyl addition polymer can initially be a copolymer of an alpha, beta-unsaturated acid and an alkyl (meth)acrylate, which then is reacted with a glycidyl halide or tosylate, e.g., glycidyl chloride, to position pendant glycidyl groups on the acrylate copolymer. The alpha, beta-unsaturated carboxylic acid can be an acid listed above, for example. In an alternative embodiment, a vinyl addition polymer having pendant hydroxyl groups first is formed. The vinyl addition polymer having pendant hydroxyl groups can be prepared by incorporating a monomer like 2-hydroxyethyl methacrylate or 3-hydroxypropyl methacrylate into the vinyl addition polymer. The polymer then is reacted to position pendant glycidyl groups on the polymer.

The amount of oxirane-functional monomer used to form the oxirane-functional vinyl addition polymer will depend on the desired oxirane functionality and the desired molecular weight of the polymer as well as the weight of the oxirane-functional monomer used. It is presently believed that the oxirane functionality of the formed polymer is preferably at least 0.5, more preferably at least 0.9, even more preferably at least 1.2, and most preferably at least 1.4. It is presently believed that the oxirane functionality of the formed polymer is preferably at most 5, more preferably at most 3, even more preferably at most 2.5, and most preferably at most 2. While not intending to be bound by theory, an oxirane functionality above 5 tends to cause premature gellation of the composition and an oxirane functionality below 0.5 tends to be insufficient to promote the desired physical properties.

It is also presently believed that for glass coating applications, the number average molecular weight (Mn) of the oxirane-functional vinyl addition polymer is preferably at least 2,500, more preferably at least 4,000, even more preferably at least 5,000, and most preferably at least 6,000. It is also presently believed that for glass coating applications, the number average molecular weight (Mn) of the oxirane-functional vinyl addition polymer is preferably at most 20,000, more preferably at most 16,000, even more preferably at most 12,000, and most preferably at most 8,000.

Using the above oxirane-functionality figures as a guide, and using an oxirane-functional monomer with a molecular weight similar to GMA, for a 7,000 Mn oxirane-functional polymer the amount of oxirane-functional monomer used is preferably at least 1, more preferably at least 2, even more preferably at least 2.5, and most preferably at least 3 wt-%, based on the weight of the other monomers used to form the polymer. Using the above oxirane-functionality figures as a guide, and using an oxirane-functional monomer with a molecular weight similar to GMA, for a 7,000 Mn oxirane-functional polymer the amount of oxirane-functional monomer used is suitably at most 10, preferably at most 5, more preferably at most 4, and most preferably at most 3.5 wt-%, based on the weight of the other monomers used to form the polymer. If oxirane-functional monomers other than GMA are used, or if the desired molecular weight is different, the amounts may need to be adjusted to account for the different weights.

The oxirane-functional monomer is preferably reacted with suitable other monomers (and optional hydroxy-functional monomers). Suitable other monomers include alkyl (meth)acrylates, vinyl monomers, and the like.

Suitable alkyl (meth)acrylates include those having the structure: CH₂═C(R¹)—CO—OR² wherein R¹ is hydrogen or methyl, and R² is an alkyl group preferably containing 1 to 16 carbon atoms. In some embodiments, R² is hydrogen. The R² group can be substituted with 1 or more, and typically 1 to 3, moieties such as hydroxy, halo, phenyl, and alkoxy, for example. Suitable alkyl (meth)acrylates therefore encompass hydroxy alkyl (meth)acrylates. The alkyl (meth)acrylate typically is an ester of acrylic or methacrylic acid. Preferably, R¹ is hydrogen or methyl and R²is an alkyl group having 2 to 8 carbon atoms. Most preferably, R¹ is hydrogen or methyl and R² is an alkyl group having 2 to 4 carbon atoms. Examples of suitable alkyl (meth)acrylates include, but are not limited to, methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isoamyl (meth)acrylate, hexyl (meth)acrylate, 2-ethylhexyl (meth)acrylate, cyclohexyl (meth)acrylate, decyl (meth)acrylate, isodecyl (meth)acrylate, benzyl (meth)acrylate, lauryl (meth)acrylate, isobomyl (meth)acrylate, octyl (meth)acrylate, nonyl (meth)acrylate, and mixtures thereof.

Suitable vinyl monomers include styrene, methyl styrene, halostyrene, isoprene, diallylphthalate, divinylbenzene, conjugated butadiene, alpha-methylstyrene, vinyl toluene, vinyl naphthalene, and mixtures thereof. The vinyl aromatic monomers described below in connection with the acid-functional polymer are also suitable for use in this polymer. Styrene is a presently preferred vinyl monomer, in part due to its relatively low cost. Preferred oxirane-functional polymers are prepared from up to 99, more preferably up to 80, and most preferably up to 70 wt-% vinyl monomer(s), based on the total weight of the monomers. Preferred oxirane-functional polymers are prepared from at least 30, more preferably at least 40, and most preferably at least 50 wt-% vinyl monomer(s), based on the total weight of the monomers.

Other suitable polymerizable vinyl monomers include acrylonitrile, acrylamide, methacrylamide, methacrylonitrile, vinyl acetate, vinyl propionate, vinyl butyrate, vinyl stearate, isobutoxymethyl acrylamide, and the like, and mixtures thereof.

In preferred embodiments, the polymer is formed using one or more optional hydroxy-functional monomers (e.g., hydroxyethyl acrylate (HEA), hydroxyethyl methacrylate (HEMA), hydroxypropyl (meth)acrylate (HPMA), etc.). Typically, the amount of hydroxy-functional monomer will be selected to achieve the desired hydroxyl-functionality. Preferred oxirane-functional polymers are prepared from at least 10, more preferably at least 15, and most preferably at least 30 wt-% hydroxy-functional monomer(s) (if used), based on the total weight of the monomers used. Preferred oxirane-functional polymers are prepared from at most 60, more preferably at most 50, and most preferably at most 45 wt-% hydroxy-functional monomer(s) (if used), based on the total weight of the monomers used.

The aforementioned monomers may be polymerized by standard free radical polymerization techniques, e.g., using initiators such as azoalkanes, peroxides or peroxy esters, to provide an oxirane-functional polymer. This reaction may be carried out using suitable solvents, if desired.

In one preferred general embodiment, the oxirane-functional vinyl addition polymer can be prepared from a reaction mixture that includes (by weight) 30 to 70 parts styrene; 3 to 10 parts glycidyl (meth)acrylate; and 30 to 70 parts hydroxyalkyl (meth)acrylate. In one specific embodiment, the oxirane-functional vinyl addition polymer can be prepared from a reaction mixture that includes (by weight) 50 parts styrene; 5 parts GMA; and 45 parts HEMA. In another specific embodiment, the polymer can be prepared from a reaction mixture that includes (by weight) 55 parts styrene; 3 parts GMA; and 42 parts HEMA. These embodiments are illustrative of suitable such oxirane-functional polymers.

Suitable acid-functional polymers include poly-acid or poly-anhydride polymers, e.g., homopolymers or copolymers prepared from ethylenically unsaturated acid or anhydride monomers (e.g., carboxylic acid or carboxylic anhydride monomers) and other optional monomers (e.g., vinyl monomers). It is also anticipated that acid-functional polyester polymers may be utilized.

Preferred acid-functional polymers utilized in this invention include those prepared by conventional free radical polymerization techniques of at least 15, more preferably at least 20 wt-%, unsaturated acid-functional monomer and the balance other unsaturated monomer. The choice of the unsaturated monomer(s) is dictated by the intended end use of the coating composition and is practically unlimited. This reaction is conveniently carried out in solution, though other neat processes may be used if desired. Low molecular weight polymers are preferred for certain applications as is discussed herein.

A variety of acid-functional and anhydride-functional monomers can be used; their selection is dependent on the desired final polymer properties.

Suitable ethylenically unsaturated acid-functional monomers and anhydride-functional monomers for the present invention include monomers having a reactive carbon-carbon double bond and an acidic or anhydride group. Preferred such monomers have from 3 to 20 carbons, 1 to 4 sites of unsaturation, and from 1 to 5 acid or anhydride groups or salts thereof.

Suitable acid-functional monomers include ethylenically unsaturated acids (mono-protic or diprotic), anhydrides or monoesters of a dibasic acid, which are copolymerizable with the optional other monomer(s) used to prepare the polymer. Illustrative monobasic acids are those represented by the structure CH₂═C(R³)—COOH, where R is hydrogen or an alkyl group of 1 to 6 carbon atoms. Suitable dibasic acids are those represented by the formulas R⁴(COOH)C═C(COOH)R⁵ and R⁴(R⁵)C═C(COOH)R⁶COOH, where R⁴ and R⁵ are hydrogen, an alkyl group of 1 to 8 carbon atoms, halogen, cycloalkyl of 3 to 7 carbon atoms or phenyl, and R⁶ is an alkylene group of 1 to 6 carbon atoms. Half-esters of these acids with alkanols of 1 to 8 carbon atoms are also suitable.

Examples of useful ethylenically unsaturated acid-functional monomers include acids such as, for example, acrylic acid, methacrylic acid, alpha-chloroacrylic acid, alpha-cyanoacrylic acid, crotonic acid, alpha-phenylacrylic acid, beta-acryloxypropionic acid, fumaric acid, maleic acid, sorbic acid, alpha-chlorosorbic acid, angelic acid, cinnamic acid, p-chlorocinnamic acid, beta-stearylacrylic acid, citraconic acid, mesaconic acid, glutaconic acid, aconitic acid, tricarboxyethylene, 2-methyl maleic acid, itaconic acid, 2-methyl itaconic acid, methyleneglutaric acid, and the like or mixtures thereof. Preferred unsaturated acid-functional monomers include acrylic acid, methacrylic acid, crotonic acid, fumaric acid, maleic acid, 2-methyl maleic acid, itaconic acid, 2-methyl itaconic acid and mixtures thereof. More preferred unsaturated acid-functional monomers include acrylic acid, methacrylic acid, crotonic acid, fumaric acid, maleic acid, itaconic acid, and mixtures thereof. Most preferred unsaturated acid-functional monomers include acrylic acid, methacrylic acid, maleic acid, crotonic acid, and mixtures thereof.

Examples of suitable ethylenically unsaturated anhydride monomers include compounds derived from the above acids (e.g., as pure anhydride or mixtures of such). Preferred anhydrides include acrylic anhydride, methacrylic anhydride, and maleic anhydride. If desired, salts of the above acids may also be employed.

Suitable other monomers include the aforementioned alkyl (meth)acrylates, vinyl monomers, and the like. It is generally preferred that amine-functional monomers be avoided.

Vinyl aromatic monomers are preferably copolymerized with the acid-functional monomers. Suitable such monomers include those represented by the structure: Ar—C(R⁸)═C(R⁹)(R¹⁰), where R⁸, R⁹, and R¹⁰ are hydrogen or an alkyl group of 1 to 5 carbon atoms and Ar is a substituted or unsubstituted aromatic group. Illustrative of these monomers are styrene, methyl styrene, vinyl toluene, and the like. The vinyl aromatic monomers can be present from 0-80% of the acid-functional polymer, preferably from 5-50%, and most preferably from 5-40%.

Other commonly utilized monomers are the unsaturated nitriles represented by the structure: R¹¹(R¹²)C═C(R¹³)—CN, where R¹¹ and R¹² are hydrogen, an alkyl group of 1 to 18 carbon atoms, tolyl, benzyl or phenyl, and R¹³ is hydrogen or methyl. Most commonly utilized are acrylonitrile and methacrylonitrile. The nitrile monomer can be present from 0-40% based on the acid-functional polymer.

Other suitable monomers are esters of acrylic acid, methacrylic acid or mixtures thereof with C1-C16 alkanols. Preferred esters are the methyl, ethyl, propyl, n-butyl isobutyl, and 2-ethylhexyl esters of acrylic acid or methacrylic acid or mixtures of such esters.

One can also utilize hydroxyalkyl (meth)acrylate monomers such as hydroxyethyl acrylate, hydroxypropyl acrylate, hydroxyethyl methacrylate, hydroxypropyl methacrylate or mixtures thereof.

It may be desirable, for certain uses, to include in the polymer acrylamide, methacrylamide or an N-alkoxymethyl (meth)acrylamide such as N-isobutoxymethyl (meth)acrylamide. Alternatively, a polymer containing copolymerized acrylamide or methacrylamide can be post-reacted with formaldehyde and an alkanol to produce an N-alkoxymethylated polymer.

The acid-functional polymers can be prepared by polymerizing suitable monomers, in proper amounts, in a suitable carrier (e.g., an organic liquid medium). Preferably, the liquid medium for the polymerization is an alcohol mixture. A catalyst or polymerization initiator is ordinarily used in the polymerization of the acid-functional polymers, in the usual amounts. This can be any free radical initiator. Azoalkanes, peroxides, tertiary butyl perbenzoate, tertiary butyl peroxypivalate, and tertiary butyl peroxyisobutyrate are suitable.

Preferred acid-functional polymers have an AN of at least 30, preferably at least 100, more preferably at least 150, and most preferably at least 200, mg KOH/gram solid. Preferred acid-functional polymers have an AN of at most 500, preferably at most 400, more preferably at most 350, and most preferably at most 320, mg KOH/gram solid. For example, 23 wt-% of MAA would provide a polymer of approximately 150 AN.

Preferred acid-functional polymers have a number average molecular weight (Mn) of at least 2,000, preferably at least 3,000, more preferably at least 4,000, and most preferably at least 5,000. Preferred acid-functional polymers have a number average molecular weight (Mn) of at most 15,000, preferably at most 12,000, more preferably at most 9,000, and most preferably at most 6,000.

In one preferred general embodiment, the acid-functional polymer can be prepared from a reaction mixture that includes (by weight) 5 to 20 parts styrene, 30 to 70 parts alkyl (meth)acrylate, and 30 to 70 parts acidic-functional monomer. In one specific embodiment, the acid-functional polymer can be prepared from a reaction mixture that includes (by weight) 10 parts styrene, 45 butyl methacrylate, and 45 parts MAA. In another specific embodiment, the acid-functional polymer can be prepared from a reaction mixture that includes (by weight) 30 parts styrene, 10 parts ethyl acrylate, and 60 parts MAA. These embodiments are illustrative of suitable such polymers.

The oxirane-functional polymer (or monomers for preparing such polymer) and the acid-functional polymer (or monomers for preparing such polymer) are preferably reacted together in the presence of a tertiary amine and a small amount of water. Under such conditions an acid group, an oxirane group, and an amine form a quaternary salt. This linkage is favored, as it not only links the polymers but promotes water dispersibility of the joined polymer. It should be noted that an acid group and an oxirane group may also form an ester. Some of this reaction is possible, though this linkage is less desirable when water dispersibility is sought.

In one embodiment, an aqueous solution (or dispersion) of a tertiary amine is brought in contact with a solution (or dispersion) of an oxirane-functional polymer in a suitable carrier (e.g., a suitable organic liquid) or with a solution (or dispersion) of an oxirane-functional polymer and an acid-functional polymer. A wide variety of carriers can be used to dissolve or disperse (preferably dissolve) the oxirane-functional polymers and the acid-functional polymers. Among the most commonly used carriers are alcohols such as isopropanol, the butyl alcohols, 2-hydroxy-4-methyl-pentane, 2-ethylhexyl alcohol, cyclohexanol, glycols such as ethylene glycol, diethylene glycol, 1,3-butylene glycol, ether alcohols such as ethylene glycol mono-ethyl ether, ethylene glycol mono-butyl ether, diethylene glycol mono-methyl ether, mixtures thereof, and many aliphatic and aromatic hydrocarbons particularly if used admixed with at least one of the above.

While the exact mode of reaction is not fully understood, it is believed that a competition between two reactions exists. One reaction involves the tertiary amine first reacting with the acid-functional polymer forming an amine-neutralized ion which can then react with the oxirane-functional polymer. A second reaction may involve the free tertiary amine reacting directly with the oxirane-functional polymer. In either case, the respective products formed are the hydroxy ester of the oxirane-functional polymer with the acid-functional polymer and a polymeric quaternary ammonium-amine mixed salt (from the tertiary amine, oxirane-functional polymer, and the acid-functional polymer). Reaction conditions, including the presence of water as a reaction modifier, can be chosen to favor either the esterification or quatemization reaction. A high level of quatemization improves water dispersability while a high level of esterification gives higher viscosity and possibly gel-like material. By varying the ratio of the reactants and reaction conditions, the solids content, viscosity, particle size and application properties of the product can be varied over a wide range.

The reaction of tertiary amines with materials containing oxirane groups, when carried out in the presence of water, can afford a product that contains both a hydroxyl group and a quaternary ammonium hydroxide.

The preparation of the water-borne coating composition is preferably carried out utilizing at least one tertiary amine (including, for example, amines having the formula: R¹⁴R¹⁵R¹⁶N, wherein R¹⁴, R¹⁵ and R¹⁶ are substituted or unsubstituted monovalent alkyl groups (preferably containing 1 to 8 carbon atoms, and more preferably containing 1 to 4 carbon atoms).

Some examples of suitable tertiary amines are trimethyl amine, dimethyl ethanol amine (also known as dimethyl amino ethanol), methyl diethanol amine, ethyl methyl ethanol amine, dimethyl ethyl amine, dimethyl propyl amine, dimethyl 3-hydroxy-1-propyl amine, dimethylbenzyl amine, dimethyl 2-hydroxy-1-propyl amine, diethyl methyl amine, dimethyl 1-hydroxy-2-propyl amine, triethyl amine, tributyl amine, N-methyl morpholine and mixtures thereof. Other examples of tertiary amines are disclosed, for example, in U.S. Pat. Nos. 6,300,428; 6,087,417; 4,247,439; 5,830,952; 4,021,396; 5,296,525; 4,480,058; 4,442,246; 4,446,258; and 4,476,262, which are herein incorporated by reference. Most preferably trimethyl amine or dimethyl ethanol amine is used as the tertiary amine.

The amount of tertiary amine employed is typically determined by various factors. As a minimum, there is preferably required at least 0.8 equivalent of tertiary amine per equivalent of oxirane groups, more preferably at least 2 equivalents, and even more preferably at least 3 equivalents, of tertiary amine per equivalent of oxirane groups for the formation of stable dispersions. As the ratio of the number of acid groups in the acid-functional polymer to the number of oxirane groups in the oxirane-functional polymer increases, the amount of amine is also increased to keep the acid-functional polymer water dispersible. This excess amine is believed to form a salt with some or all of the excess acid groups of the polymer. It is preferred that no excess amine, over the total number of equivalents of acid groups, be used in the coating composition of this invention.

The stoichiometric ratio of amine to oxirane (“A:Ox”) can influence the viscosity of the composition. In general as the A:Ox ratio increases, viscosity decreases. It should be noted that this trend may not always be true as dispersion conditions have been found to also impact viscosity. Preferably the A:Ox ratio is at least 0.8:1, more preferably at least 2:1, and most preferably at least 2.5:1. Preferably the A:Ox ratio is at most 5:1, more preferably at most 4:1, and most preferably at most 3.5:1. Additional amine may be added after the polymer has been dispersed to further adjust viscosity.

The weight ratio of oxirane-functional polymer to acid-functional polymer is typically at least 90:10, preferably at least 87:13, and more preferably at least 84:16. The weight ratio of oxirane-functional polymer to acid-functional polymer is typically at most 50:50, preferably at most 70:30, and more preferably at most 80:20.

The water-borne coating composition of this invention can be prepared without regard to the sequence of addition of the various components. Although it is preferred that the water-dispersible polymer is prepared from preformed polymers (e.g., oxirane-functional vinyl addition polymer and acid-functional polymer), it is possible that monomers for one of the polymers can be reacted with the other polymer that is either preformed or formed in-situ. If desired, an acid-functional polymer can be combined with a tertiary amine to at least partially neutralize the acid-functional polymer prior to reaction with the an oxirane-functional polymer or monomers for formation of an oxirane-functional polymer.

It is preferred, however, to first dissolve the oxirane-functional polymer in the acid-functional polymer, in presence of suitable carriers (e.g., organic liquids). Addition of a suitable tertiary amine, usually dissolved in water, completes the preparation of the polymeric quaternary ammonium salt of a polymeric acid. Additional water can then be added to achieve an aqueous dispersion. Additional amine can also be added to insure dispersibility or adjust viscosity.

Preferably, the reaction can be carried out at a temperature of at least room temperature (e.g., 25° C.), more preferably at least 50° C., and most preferably at least 90° C. Preferably, the reaction can be carried out at a temperature of below the boiling point of the reaction medium, and more preferably at a temperature of at most 100° C. In this temperature range there is a rapid rate of reaction.

In another preferred method of preparation of the coating composition, an oxirane-functional polymer is dissolved in a suitable carrier such as the mono-butyl ether of ethylene glycol or diethylene glycol, followed by the addition of a suitable tertiary amine. After the formation of the polymeric quaternary ammonium hydroxide is substantially complete, an acid-functional polymer, dissolved or dispersed in a suitable carrier is mixed with it with agitation. This latter solution or dispersion can also contain any additional suitable amine, dissolved in water, necessary for dispersability of the coating composition. Mixing of the components completes the preparation of the water-borne coating composition. This sequence of steps can also be carried out between room temperature and temperatures below the boiling point of the reaction media.

The resultant product is a cured film that includes a crosslinked polymer having a crosslink segment of the general formula:

—Y—C(R²)—C(R)(OH)—C(R²)—O—(O)C—Xᵣ—,

wherein:
Y is a divalent organic group (preferably a C1 to C6 organic group), more preferably a divalent organic group that includes a C(O)O moiety;
X is a divalent organic group (preferably a C1 to C6 organic group);
R is H, or a C1 to C6 organic group, preferably H; and
r is 0 or 1, preferably 0.

The resin system may be dissolved in a suitable solvent to form a coating composition of the invention, or may be blended with water and/or a suitable solvent to form a coating dispersion. In presently preferred embodiments, the resin system is combined with an aqueous carrier to form a coating dispersion or solution.

In certain embodiments, it may be desirable to include a silane coupling agent, more preferably a vinyl silane coupling agent, in the coating composition. Alternatively, in some embodiments, the glass substrate may be pretreated with one or more silane coupling agents. While not intending to be bound by any theory, suitable silane coupling agents, and especially oxirane-functional silane coupling agents, are thought to promote adhesion of the coating to the underlying substrate and contribute to the excellent abrasion resistance. In particular, in certain embodiments, oxirane groups (when present) of the silane coupling agent are thought to react with the glass substrate and/or acid groups present on the resin system to provide the aforementioned benefits.

Examples of suitable silane coupling agents include vinyl silane coupling agents such as the SILQUEST A-1100 or SILQUEST A-162 products (both commercially available from GE Silicones); oxirane-functional silane coupling agents, such as the SILQUEST A-186 or SILQUEST A-187 products (both commercially available from GE Silicones); and mixtures thereof.

Preferred coating compositions contain at least about 0.1, more preferably at least about 1, and more preferably at least about 3 wt-% of silane coupling agent, based on the total nonvolatile weight of the coating composition. Preferred coating compositions contain less than about 15, more preferably less than about 12, and even more preferably less than about 9 wt-% of silane coupling agent, based on the total nonvolatile weight of the coating composition.

As previously discussed, conventional colored glass articles are typically produced using colorants that are incorporated into the raw materials of the glass batch. Coating compositions of the invention may include one or more colorants or aesthetic additives to provide a coated article (or portion thereof) having a desired color and/or aesthetic property. A colorant package included in the coating compositions may be configured to affect a color change, thereby eliminating the need to use different glass stock when desiring a glass article of a different color.

The particular additive(s) used to achieve a desired color and/or aesthetic property will vary depending upon the desired properties. Examples of suitable additives include carbon black, titanium dioxide, organic pigments, organic dyes, matting additives, frosting additives, opacifying additives, metallizing additives, and combinations thereof.

In addition to allowing glass articles of different colors to be produced on demand using a common glass stock, the coating composition of the invention has the potential to ease the process of recycling glass. For example, if a plurality of differently colored glass articles were produced from clear glass by coating the glass with differently colored coating compositions of the invention, the need for segregating the articles by color for recycling would be eliminated since the coating composition will volatilize off in the high temperature furnaces typically used to recycle glass.

Coating compositions of the invention may include one or more optional crosslinkers. The choice of crosslinker typically depends on the particular product being formulated. For example, crosslinkers that tend to have a yellowish color (e.g., certain phenolic crosslinkers) may be utilized in coating compositions where such a color is acceptable or desirable. In contrast, clear and white coatings are generally formulated using non-yellowing crosslinkers, or only a small amount of a yellowing crosslinker.

The concentration of crosslinker included in the coating compositions may vary depending upon the desired result. While not intending to be bound by any theory, in certain embodiments, inclusion of a suitable amount of crosslinker is thought to enhance abrasion resistance. Preferred coating compositions include at least about 0.5, more preferably at least about 5, and even more preferably at least about 15 wt-% of crosslinker, based on the total nonvolatile weight of the coating composition. Preferred coating compositions contain less than about 45, more preferably less than about 35, and even more preferably less than about 25 wt-% of crosslinker, based on the total nonvolatile weight of the coating composition.

Any suitable crosslinker or combination of crosslinkers can be used. For example, phenolic crosslinkers, amino crosslinkers, glycourils, ionic metal driers, and combinations thereof, may be used.

Amino crosslinker resins (e.g., aminoplasts) are typically the condensation products of aldehydes (e.g., such as formaldehyde, acetaldehyde, crotonaldehyde, and benzaldehyde) with amino- or amido-group-containing substances (e.g., urea, melamine and benzoguanamine). Suitable amino crosslinking resins include, for example, benzoguanamine-formaldehyde-based resins, melamine-formaldehyde-based resins (e.g., hexamethonymethyl melamine), etherified melamine-formaldehyde, and urea-formadehyde-based resins. Melamine formaldehyde crosslinkers are presently preferred.

Condensation products of other amines and amides can also be employed such as, for example, aldehyde condensates of triazines, diazines, triazoles, guanadines, guanamines and alkyl- and aryl-substituted melamines. Some examples of such compounds are N,N′-dimethyl urea, benzourea, dicyandimide, formaguanamine, acetoguanamine, glycoluril, ammelin 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. While the aldehyde employed is typically formaldehyde, other similar condensation products can be made from other aldehydes, such as acetaldehyde, crotonaldehyde, acrolein, benzaldehyde, furfural, glyoxal and the like, and mixtures thereof.

Suitable commercially available amino crosslinking resins may include, for example, the CYMEL 301, CYMEL 303, CYMEL 325, CYMEL 370, CYMEL 373, CYMEL 1131, CYMEL 1125, CYMEL 1156, and CYMEL 5010 Maprenal MF 980 products (all available from Cytec Industries Inc., West Patterson, N.J.) and the URAMEX BF 892 product (available from DSM, Netherlands).

Examples of suitable phenolic crosslinkers (e.g., phenoplasts) include the reaction products of aldehydes with phenols. Formaldehyde and acetaldehyde are preferred aldehydes. Examples of suitable phenols that can be employed include phenol, cresol, p-phenylphenol, p-tert-butylphenol, p-tert-amylphenol, cyclopentylphenol, cresylic acid, BPA, and combinations thereof. Examples of suitable commercially-available phenolic compounds may include the BAKELITE 6535LB, 6581 LB, and 6812LB (each available from Hexion Specialty Chemicals GmbH), DUREZ 33162 (Durez Corporation, Addison, Tex.), PHENODUR PR 285 55/IB/B and PR 897 (each available from CYTEC Surface Specialties, Smyrna, Ga.), and SANTOLINK EP 560 products.

In some embodiments, the coating composition includes a catalyst to increase the rate of cure. If used, a catalyst is preferably present in an amount of at least about 0.05, and more preferably at least about 0.1 wt-% of nonvolatile material. If used, a catalyst is preferably present in an amount of less than about 1, and more preferably less than about 0.5 wt-% of nonvolatile material. Examples of suitable catalysts include acid catalysts such as phosphoric acid, citric acid, dinonylnaphthalene disulfonic acid (DNNSA), dodecylbenzene disulfonic acid (DDBSA), p-toluene sulfonic acid (p-TSA), dinonylnaphthalene disulfonic acid (DNNDSA), phenyl acid phosphate (PAP), alkyl acid phosphate (AAP), and the like, and mixtures thereof.

Certain packaged products (e.g., beer) are sensitive to prolonged exposure to natural or artificial light. As such, in certain embodiments, it may be desirable to include additives that block, reflect, and/or absorb certain wavelengths of light. For example, UV stabilizers may be included in coating compositions intended for application to glass beer containers. Suitable UV stabilizers, compatible with water-based systems, may include, for example, compounds drawn from the hindered amine, benzophenone, benzotriazole and triazine classes of UV stabilizers. Examples of suitable commercial UV stabilizers include the TINUVIN line of products (Ciba Specialties) and the CYASORB line of products (Cytec). A preferred UV stabilizer for use in the invention is the TINUVIN 1130 product.

A leveling agent may be included in coating compositions of the invention. The leveling agent may, for example, facilitate spray application of the coating composition, avoid running of an applied coating composition, and/or facilitate production of a smooth and aesthetically pleasing cured coating.

The coating compositions may optionally include any other suitable additives that do not adversely affect the coating composition or a cured coating resulting therefrom. Suitable additives include, for example, those that improve the processability or manufacturability of the composition, enhance composition aesthetics, or improve a particular functional property or characteristic of the composition, such as adhesion of the cured composition to a substrate. Additives that may be included are carriers, emulsifiers, pigments, metal powders or paste, fillers, anti-migration aids, anti-microbials, extenders, curing agents, lubricants, coalescents, wetting agents, biocides, plasticizers, antifoaming agents, colorants, waxes, anti-oxidants, anticorrosion agents, flow control agents, thixotropic agents, dispersants, adhesion promoters, scavenger agents, or combinations thereof. Each optional ingredient can be included in a sufficient amount to serve its intended purpose, but preferably not in such an amount to adversely affect a coating composition or a cured coating composition resulting therefrom.

The amount of solids included in the coating compositions may vary depending upon, for example, the method of coating application. In certain embodiments, the coating compositions include at least about 10, more preferably at least about 15, and even more preferably at least about 20 wt-% of solids (i.e., non-volatile content), based on the total weight of the coating composition. In certain embodiments, the coating compositions include less than about 50, more preferably less than about 40, and even more preferably less than about 30 wt-% of solids, based on the total weight of the coating composition.

Preferred coating compositions of the invention exhibit excellent storage stability when stored under ambient conditions. In addition, preferred coating compositions also exhibit suitable adhesion, recyclability, and pot-life. The term “pot-life” as used herein refers to the time period for which a liquid coating composition can be stored under ambient conditions without exhibiting unsuitable amounts of gellation or degradation. Preferred coating compositions of the invention exhibit a pot-life of at least about 1 month, more preferably at least about 3 months, even more preferably at least about 6 months, and optimally at least about 1 year.

The coating composition may be applied to a substrate using any suitable method, such as, for example, spray coating, roll coating, dip coating, etc. Spray coating is a presently preferred method for applying coating composition to an exterior surface of glass bottles. After application to a substrate, the coating composition is preferably cured to form a crosslinked coating. Any suitable curing process can be employed, including, for example, oven baking by either conventional or convectional methods. The curing process may be performed in either discrete or combined steps. For example, substrates can be dried at ambient or elevated temperature to leave the coating compositions in a largely un-crosslinked state. The coated substrates can then be heated to fully cure the compositions. In certain instances, coating compositions can be dried and cured in one step.

The curing process may be performed at any suitable temperature for any suitable period of time sufficient to achieve the desired result. In presently preferred embodiments, the coating composition is cured at a temperature of at least about 190° C., more preferably at least about 205° C., for about 15 minutes.

The coating compositions may be used to coat a variety of articles including glass substrate. Examples of such articles may include beer or soda bottles, wine bottles, liquor bottles, pharmaceutical containers, cosmetic containers, perfume containers, candle holders, dishware (e.g., plates, stemware, mugs, etc.), vases, glass tile, glass mosaics, shaped components for mirror application, window glass, and molded components for various applications (e.g., automotive, aviation, etc.).

The coating compositions may be applied to an article as either a single layer (presently preferred) or in a plurality of layers. The coating composition may be applied either directly to a glass substrate or to a coating overlying the glass substrate (e.g., a “cold end” coating such as a wax or fatty acid coating (e.g., stearate or oleate) or a “hot end” coating such as a tin-oxide coating).

The coating composition of the invention may exhibit mechanical properties that reinforce a substrate of an article. Such properties may enable the thickness of a glass substrate to be thinned, thereby reducing an amount of glass material used to produce an article.

Preferred coating compositions of the invention are particularly suited for use as external coatings for glass beer and beverage bottles produced and/or bottled on high-speed lines. As discussed above, preferred coating compositions exhibit excellent resistance to abrasion in such demanding applications, as well as excellent pasteurization resistance, pot-life, recyclability, and aesthetics. In one such embodiment, the following method is used to provide a glass beer container coated with a cured coating of the present invention:
A glass beer container is formed.
An optional “hot end” coating composition such as, for example, tin-oxide is applied to an exterior surface of the beer container to provide an initial protective coating to prevent scratching.
The coated beer container is then annealed at a suitable temperature for a suitable time period.
An optional “cold end” coating composition such as, for example, a wax or fatty acid composition is then provided (e.g., as a “sacrificial” layer to scratch instead of the underlying glass), or in some embodiments, the optional cold end coating is not employed.
A coating composition of the invention is then applied over the exterior surface and suitably cured to form a beer container having a cured coating thereon.

### Test Methods

The following test methods may be utilized to assess the performance properties of coating compositions of the invention. Unless indicated otherwise, the following test methods were utilized in the Examples that follow.

### Abrasion Resistance Tests

A. Taber Abrasion Test

This test provides an indication of the ability of a coating applied to a glass substrate to withstand abrasive conditions. In particular, this test assesses the resistance of a coating cured on a flat plate of glass to abrasive forces produced by a Taber Abrader. The testing is performed pursuant to the procedures of ASTM D4060-01, Annual Book of ASTM standards, Volume 09.01, using a single CS-10F calibrase wheel. The coating compositions are applied at 0.05 mil (equivalent to 0.0013 millimeters (“mm”)) dry film weight on 4 inch by 4 inch by ⅛ inch (equivalent to 10.16 centimeters (“cm”) by 10.16 cm by 0.32 cm) flat pieces of soda lime glass that have been run through a tin compound before annealing. The coating compositions are applied and cured on the tin-free side of the glass. Organic coatings typically exhibit reduced adhesion to a tin-free side of flat glass panels as compared to a tin-coated side. Thus, employing a tin-free side provides a more rigorous test.

Preferred coating compositions of the invention, when cured and tested as described above, exhibit a taber abrasion resistance of at least 100 cycles. As used herein, a coating composition that “exhibits a taber abrasion resistance of at least 100 cycles” is able to withstand at least 100 cycles of the abrasive wheel without exhibiting any observable tearing (as determined by an unassisted human eye) of the cured coating down through to the substrate.

B. AGR Line Simulator Test

This test is run on spray coated glass bottles to mimic the type of surface abrasion typically encountered by a bottle (e.g., a glass beer bottle) during transit in filling operations. It employs a line simulator device developed by American Glass Research (AGR) of Butler, Pa. The device carries approximately 29 bottles in an annular gap between Teflon coated steel rails on a circular aluminum drive plate. The test duration (time) and speed can be varied as required by the experimenter. Bottles can be tested empty, or filled with water. They can also be tested with or without water lubrication on the exterior of the bottles. After abrading for the prescribed time period, the bottles are withdrawn and inspected for failure under a microscope. Failure is evident when chips, tears or abrasions are observed in the polymer film and the glass below becomes exposed. Samples can either be rated visually, or tearing can be measured in millimeters and reported. Visual ratings are assigned as follows:
10: no incidence of chips, tears or surface abrasion
9: 10% of region displays chips, tears, or surface abrasion
8: 20% of region displays chips, tears, or surface abrasion
7: 30% of region displays chips, tears, or surface abrasion
6: 40% of region displays chips, tears, or surface abrasion
5: 50% of region displays chips, tears, or surface abrasion
4: 60% of region displays chips, tears, or surface abrasion
3: 70% of region displays chips, tears, or surface abrasion
2: 80% of region displays chips, tears, or surface abrasion
1: 90% of region displays chips, tears, or surface abrasion

### Water Resistance Tests

The below tests each provide an indication of the ability of a cured coating to withstand conditions frequently associated with food or beverage preservation or sterilization processes (e.g., pasteurization processes associated with bottling beer).

A. Boiling Water Test

Coated substrate samples (in the form of flat glass panels) are placed in a vessel and immersed for 30 minutes in deionized water (“DI water”) having a temperature of 100° C. After pasteurization, the coated substrate samples are dried and tested immediately for adhesion and blush resistance.

B. Water Immersion Test

Coated substrate samples (in the form of flat glass panels) are soaked in a vessel of DI water for 3 days at 26° C. After 3 days, the coated substrate samples are dried and tested immediately for adhesion and blush resistance.

C. Pasteurization Test

Spray coated and cured bottles are filled with DI water at 74° C. and then placed upright in a DI water bath for 30 minutes. After 30 minutes, the bottles are emptied and transferred to a water bath at 50° C. To prevent thermal shock, the water temperature is gradually reduced to room temperature with warm water then flushed with cool water at 21° C. Bottles are removed from the cooling water bath and tested immediately for adhesion and blush resistance.

### Blush Resistance Test

Blush resistance measures the ability of a cured coating to resist attack by various solutions. Typically, blush is measured by the amount of water absorbed into a coating. When the coating absorbs water, it generally becomes cloudy or looks white. Blush is generally measured visually using a scale of 0-10 where a rating of “10” indicates no blush and a rating of “0” indicates complete whitening of the film. Samples of coated substrate were rated for blush as follows:
10: no observed blushing to the coating
8-9: a very slight haze observed on the surface of the coating
7: a slightly cloudy appearance to the coating observed
5-6: a moderate cloudy appearance to the coating observed
3-4: a cloudy appearance to the coating observed
1-2: near-complete whitening of the coating observed
0: complete whitening of the coating observed

Blush ratings of at least 7 are typically desired for commercially viable coatings and optimally 9 or above.

A coating is considered herein to satisfy the Blush Resistance Test if it exhibits a blush rating of at least 7 when tested as described above. Preferred cured coatings of the invention after pasteurization pursuant to the Pasteurization Test exhibit a blush rating of preferably at least 7, more preferably at least 8, even more preferably at least 9, and most preferably 10, when tested as described above.

### Adhesion Test

A useful test for assessing whether coating compositions adhere well to a substrate is the ASTM D 3359—Test Method B. performed using SCOTCH 610 tape, available from 3M Company of Saint Paul, Minn. (referred to herein as the “Adhesion Test”). Adhesion is generally rated on a scale of 0-10 where a rating of “10” indicates no adhesion failure, a rating of “9” indicates 90% of the coating remains adhered, a rating of “8” indicates 80% of the coating remains adhered, and so on.

Preferred cured coating systems of the invention (before pasteurization) exhibit an adhesion on the above scale of at least about 8, more preferably at least about 9, and even more preferably 10. After being pasteurized pursuant to the above Pasteurization Test, preferred cured coating systems of the invention exhibit an adhesion of at least about 8, more preferably at least about 9, and even more preferably 10.

### Solvent Resistance Test

The extent of cure of a coating is measured as a resistance to solvents such as methyl ethyl ketone (“MEK”). This test is performed as described in ASTM D 5402-93. A 4 inch by 5 inch (i.e., 10.16 cm by 12.7 cm) coated glass panel is manually rubbed in a back-and-forth motion using a clean cheesecloth soaked in MEK. The number of double rubs (i.e., one back-and-forth motion) to failure is recorded. Failure occurs when the coating is broken through to reveal the substrate panel. Preferred cured coatings of the invention are capable of withstanding at least about 60, more preferably at least about 80, and even more preferably at least about 100 MEK rubs before failure.

### Glass Transition Temperature

Glass transition temperature (T_{g}) is determined via Differential Scanning Calorimetry. Samples of polymer, dried of their liquid vehicle component, are analyzed by heating from −60° C. to 200° C. at a rate of 20° C. per minute. The samples are cooled from 200° C. back to −60° C. and then heated a second time to 200° C. at a rate of at 20° C. per minute. The T_{g} of the polymer sample is determined during the second heating step in the temperature region where the measured heat capacity shows a sudden change in magnitude.

### EXAMPLES

The present invention is illustrated by the following examples. It is to be understood that the particular examples, materials, amounts, and procedures are to be interpreted broadly in accordance with the scope and spirit of the invention as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Mo.

### Example 1

### Water-Dispersible Resin System

A water-dispersible acrylic resin system was prepared as follows:

### 1.1: Preparation of Acid-Functional Prepolymer A

A premix of 163.6 parts glacial methacrylic acid, 163.6 butyl methacrylate, 36.4 parts styrene, and 23.4 parts benzoyl peroxide (70% water wet) was prepared in a separate vessel. A 1-liter flask was equipped with a stirrer, reflux condenser, thermocouple, heating mantle and nitrogen blanket. Ten percent of the premix was added to the flask along with 129.6 parts butanol and 9.8 parts deionized water. To the remaining premix was added 183.0 parts butanol and 12.2 parts deionized water. With a nitrogen blanket flowing in the flask, the contents were heated to 93° C. When the contents reached 93° C., external heating was stopped and the material was allowed to increase in temperature for 15 minutes. After 15 minutes, the batch was at 97° C., and the remaining premix was added uniformly over 2 hours maintaining 97° C. to 100° C. Foaming was controlled by lowering the agitation. After 3 hours the heating was discontinued and 75 parts butyl cellosolve was added. The resulting acrylic prepolymer was 44.9% NV (nonvolatiles), with an acid number of 300 and a viscosity of 24,000 centipoise.

Two additional batches were produced using the same process. The first additional batch provided a polymer having 44.7% NV, 304 acid number and a viscosity of 30,100 centipoise. The second additional batch provided a polymer having 44.7% NV, 306 acid number and a viscosity of 27,500 centipoise.

### 1.2: Preparation of Oxirane-Functional Prepolymer B

A 12-liter flask was equipped with a stirrer, reflux condenser, thermocouple, heating mantle and nitrogen blanket. In a separate vessel a monomer premix containing 1,412.4 parts styrene, 1,079.4 parts hydroxy propyl methacrylate, 77.9 parts glycidyl methacrylate, and 109.9 parts t-butyl peroctoate was prepared. To the 12-liter flask was added 297.8 parts butanol and 967.3 parts butyl cellosolve. The flask was heated to 94° C., and 17.3 parts t-butyl peroctoate was added. After 5 minutes the premix was added to the flask over 3.5 hours while maintaining 97° C. to 100° C. An initiator premix of 127.7 parts butyl cellosolve and 54.8 parts t-butyl peroctoate was prepared. When the monomer premix addition was complete, the premix vessel was rinsed with 52.3 parts butyl cellosolve. The initiator premix was immediately added over a 1-hour period. When the initiator premix addition was complete, the vessel was rinsed with 32.4 parts butyl cellosolve. The batch was held at 98° C. to 99° C. for 1 hour. At the end of the hour 5.3 parts t-butyl peroctoate was added and the batch was held 1 hour. At the end of the hour a second addition of 5.3 parts t-butyl peroctoate was added and the batch was held an additional 1 hour. At the end of the hour a third addition of 5.3 parts t-butyl peroctoate was added and the batch was held 1 hour. The batch was then cooled and yielded an acrylic prepolymer with 63.6% NV, an oxirane value of 0.021 eq/100 gram solid resin, an acid number of 2.0, and a Brookfield viscosity of 89,900 centipoise.

### 1.3: Preparation of Water-Dispersible Resin System

A 12-liter flask was equipped as described above. Into the flask was added 1,249.3 parts of the Prepolymer A and 4,072.2 parts of the acrylic Prepolymer B. The contents of the flask were heated to 97° C. Once at temperature, 61.8 parts deionized water and 136.3 parts dimethyl ethanol amine was added over 5 minutes. The batch was held for 4 hours at 99° C. to 100° C. At the end of the 4 hours, heating was stopped and 2,715.2 parts deionized water was added at high agitation over 2 hours while the temperature was allowed to decrease. Immediately after the addition, 400 parts of deionized water was added over 15 minutes. The resulting dispersion was 36.9% NV, particle size of 0.29 micron, pH of 6.84, acid number of 56.6, and a Brookfield viscosity of 6,320 centipoise.

### Example 2

### Colored Coating Composition

A colored water-based acrylic coating composition was prepared having the compositional makeup indicated in Table 1 below. The coating composition was 24 wt-% solids.

TABLE 1

| | wt-% of the total solids |
|---|---|
| Ingredient | weight of the coating |
| Acrylic Resin System of Example 1 | 40-60 |
| Melamine Crosslinkers | 15-25 |
| UV Absorber | 15-25 |
| Silane Coupling Agent | 5-10 |
| Leveling Agent | 0.1-0.5 |
| Pigment Paste | 2-5 |
| Waterbased Acrylic | 40-60 |

### Example 3

### Coating Performance on Glass Panels

The coating composition of Example 2 was applied to 0.5 mil (0.0013 mm) wet film weight onto 4 inch by 4 inch by ⅛ inch (i.e., 10.16 cm by 10.16 cm by 0.32 cm) soda lime glass panels and cured for 15 minutes in a 204° C. oven. A conventional water-based epoxy acrylate glass coating was also applied and cured using the same procedure to provide a control. Taber Abrasion, MEK Rub, Water Process Resistance and Water Immersion Resistance Tests were performed on both types of cured coatings. The results for these tests are provided in Table 2.

As illustrated in Table 2, the cured coating composition of Example 2 exhibited a significantly higher Taber Abrasion resistance and MEK rub resistance than the epoxy acrylate control. Both coating compositions displayed excellent blush after being subjected to the Water Immersion Test. However, unlike the control composition, the cured coating composition of Example 2 did not exhibit any adhesion loss after being subjected to the Boiling Water Test, while the water-based epoxy acrylate control exhibited some adhesion loss.

TABLE 2

| | Glass | | | Boiling Water | Water |
|---|---|---|---|---|---|
| Coating | Transition | **Taber | ***MEK | Test | Immersion Test |
| Composition | Temperature | Abrasion | Rubs | (Blush/Adhesion) | (Blush/Adhesion) |
| Example 2 | 86° C. | 120-150 | >100 | 10/10 | 10/10 |
| Water-based | *28° C./103° C. | <100 | 40-60 | 10/8 | 10/10 |
| Epoxy Acrylate | | | | | |
| Control | | | | | |

*Dual glass transitions of 28° C. and 103° C. were measured for the epoxy acrylate control.
**Results reported in number of cycles the coating withstood before tearing was observed.
***Results reported in number of MEK rubs the coating withstood before tearing was observed.

### Example 4

### Coating Performance on Beer Bottles

The coating composition of Example 2 and the water-based epoxy acrylate control coating composition were spray applied onto the external surface of 12-ounce clear glass beer bottles. The bottles were suspended on racks comprised of Teflon coated steel pins and cured for 15 minutes at 204° C. The resulting dry film weights of the cured coatings were between 7 and 12 milligrams/square inch (“msi”), which is equivalent to 1.1-1.9 milligrams/square centimeter (mg/cm²). The bottles were tested at AGR using the AGR Line Simulator operating at a 35 revolutions per minute (“RPM”) drive plate speed. Each coated bottle was subjected to 5 cycles on the AGR Line Simulator, with each cycle being 1 minute in duration. The bottles were tested empty both with and without tap water saturation on the exterior of the bottles. The bottles were then removed from the line simulator, observed under a microscope, and rated visually for damage in the shoulder, sidewall and heel areas. An average rating over these three areas was determined. Similarly coated bottles, not tested on the line simulator, were evaluated for pasteurization using the Pasteurization Test. The results for the above tests are provided below in Table 3.

TABLE 3

| | Rating after AGR Line | | Coating Properties | |
|---|---|---|---|---|
| | Simulator (Rating 1-10) | | after | |
| | 5 1-minute | 5 1-minute | Pasteurization Test | |
| Coating Composition | Cycles, Wet | Cycles, Dry | Blush | Adhesion |
| Example 2 | 8.4 | 8.8 | 10 | 10 |
| Water-based Epoxy | 6.2 | 6.4 | 10 | 4.5 |
| Acrylate Control | | | | |

As illustrated in Table 3, the cured coating composition of Example 2 exhibited dramatically better adhesion to a beer bottle cold end coating, as well as abrasion resistance, than did the conventional water-based epoxy acrylate control.

### Example 5

### Coating Performance on Glass Beer Bottles

The coating compositions of Example 2 and the water-based epoxy acrylate control were spray applied to the exterior surface of 12-ounce clear glass beer bottles. The bottles were suspended on racks comprised of Teflon coated steel pins, flash cured at 109° C. for 3 minutes and then cured for 15 minutes at 204° C. Dry coat weight on the bottles by this method was between 7-12 msi. The bottles were tested on the AGR Line Simulator as described in Example 4, with the exception that the bottles were filled with tap water. After testing on the AGR Line Simulator, the bottles were examined under a microscope and rated visually for damage in the shoulder, sidewall and heel areas. Damage in the heel region was measured in lineal millimeters and an average value over nine bottles was determined. Similar bottles, not tested on the line simulator, were evaluated using the Pasteurization Test. The results are provided below in Table 4. As illustrated in Table 4, the cured coating composition exhibited dramatically enhanced adhesion to the cold end coating of the beer bottle relative to the water-based epoxy acrylate control.

TABLE 4

| | Length of Heel | | Coating Properties | |
|---|---|---|---|---|
| | Tears after AGR | | after | |
| | Line Simulator Test | | Pasteurization Test | |
| Coating Composition | AVG, mm | STD, mm | Blush | Adhesion |
| Example 2 | 9 | ±6 | 10 | 9 |
| Water-based Epoxy | 29 | ±14 | 10 | 5.5 |
| Acrylate Control | | | | |

### Example 6

### Matte-Finish Acrylic Coating Composition

The water-based acrylic coating composition having the compositional makeup indicated in Table 6 below was prepared. The coating composition included matte filler to produce a matte finish and was 32.5 wt-% solids.

TABLE 5

| | wt-% based on the total solids |
|---|---|
| Ingredient | weight of the coating |
| Acrylic Resin System of Example 1 | 30-50 |
| Melamine Crosslinkers | 10-20 |
| UV Absorber | 10-20 |
| Silane Coupling Agent | 2-8 |
| Leveling Agent | 0.1-0.5 |
| Matting Fillers | 25-35 |
| Wax | 2-4 |

### Example 7

### Coating Performance on Glass Panels

The coating composition of Example 6 and a water-based epoxy acrylate control coating composition (containing a similar amount of matting fillers) were applied to 4 inch by 4 inch by ⅛ inch (i.e., 10.16 cm by 10.16 cm by 0.32 cm) soda lime glass panels to yield a 0.013 mm thick wet film weight coating. The coated glass panels were then cured for 15 minutes in a 204° C. oven. Taber Abrasion, MEIK Rub, Boiling Water, and Water Immersion Tests were performed for both coating compositions, with the results reported below in Table 6.

TABLE 6

| | | | | Coating | Coating |
|---|---|---|---|---|---|
| | | | | Properties | Properties After |
| | Glass | | | After Boiling | Water Immersion |
| | Transition | Taber | MEK | Water Test | Test |
| Coating Composition | Temperature | Abrasion | Rubs | (Blush/Adhesion) | (Blush/Adhesion) |
| Example 6 | 86° C. | 300-350 | >100 | 10/10 | 10/10 |
| Water-based Epoxy | *28° C./103° C. | 150-200 | 50-70 | 10/9.5 | 10/10 |
| Acrylate Control | | | | | |

*Dual glass transitions of 28° C. and 103° C. were measured for the epoxy acrylate control
**Results reported in number of cycles the coating withstood before tearing was observed.
***Results reported in number of MEK rubs the coating withstood before tearing was observed.

### Example 8

### Coating Performance on Glass Vases

The coating composition of Example 6 and the water-based epoxy acrylate control composition were each sprayed onto the exterior surface of decorative glass vase-ware to yield a coating having a wet film thickness of between 1.1-1.9 mg/cm². The vase-ware was baked in a 204° C. oven for 15 minutes, packed in cardboard boxes, and shipped overland 2,000 miles round trip. When the boxes returned, the coated vases were removed and visually inspected. The vases having the matte finish coating of Example 6 exhibited excellent surface appearance and did not exhibit any loss of coating on the base edges of vases. The vases having the control matte finish coating, however, exhibited heavy surface dusting and a complete loss of coating at the base edges.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A coated article comprising:
a glass substrate; and
a coating composition applied over at least a portion of the glass substrate, the coating composition comprising:
a water-dispersible resin system that includes an acrylic polymer having a T_{g} of greater than about 30° C.,
a crosslinker, and
an aqueous carrier;
wherein the coating composition, when cured on a flat glass substrate at a dry film thickness of 0.0013 millimeters, exhibits a taber abrasion resistance of at least about 100 cycles when tested pursuant to ASTM D4060-01 using a single CS-IOF calibrase wheel as the abrasive wheel.

2. The coated article of claim 1, wherein the coating composition comprises a crosslinked coating composition.

3. The coated article of claim 1, wherein the resin system comprises a heat-curable resin system.

4. The coated article of claim 1, wherein the T_{g} of the acrylic polymer is between about 60° C. and about 90° C.

5. The coated article of claim 1, wherein the acrylic polymer comprises at least about 30% of the total nonvolatile weight of the coating composition.

6. The coated article of claim 1, wherein the resin system comprises:
a reaction product of:
an oxirane-functional vinyl addition polymer having an oxirane functionality of 0.5 to 5,
an acid-functional polymer having an acid number of 30 to 500, and
a tertiary amine;
wherein at least one of the oxirane-functional vinyl addition polymer or the acid-functional polymer is the acrylic polymer having a T_{g} of greater than about 30° C.

7. The coated article of claim 6, wherein the oxirane-functional vinyl addition polymer is a reaction product of a glycidyl ester of an alpha, beta-unsaturated acid, or anhydride thereof with one or more other monomers.

8. The coated article of claim 1, wherein the coating composition comprises between about 5 and about 45% by weight solids of crosslinker.

9. The coated article of claim 1, wherein the crosslinker comprises a melamine crosslinker.

10. The coated article of claim 1, wherein the coating composition further comprises a silane coupling agent.

11. The coated article of claim 10, wherein the silane coupling agent comprises an oxirane-functional silane coupling agent.

12. The coated article of claim 1, wherein the coating composition further comprises a colorant.

13. The coated article of claim 1, wherein the coating composition further comprises a UV absorber.

14. The coated article of claim 1, wherein the coating composition is pasteurization resistant.

15. The coated article of claim 1, wherein the coating composition, when in a liquid form prior to application, is storage stable for at least about 3 months.

16. The coated article of claim 1, wherein the coated article comprises a beer or soda container.

17. The coating composition of claim 1, further comprising:
at least about 30% by weight solids of the water-dispersible resin system;
between about 5% and about 45% by weight solids of the crosslinker; and
a silane coupling agent.

18. The coating composition of claim 17, wherein the silane-coupling agent comprises an oxirane-functional silane coupling agent.

19. The composition of claim 17, wherein the water-dispersible acrylic resin system comprises:
a reaction product of an oxirane-functional vinyl addition polymer having an oxirane functionality of 0.5 to 5, an acid-functional polymer having an acid number of 30 to 500, and a tertiary amine.

20. A method comprising:
providing a glass substrate
providing a coating composition comprising:
a water-dispersible resin system that includes an acrylic polymer having a T_{g} of greater than about 30° C.,
a crosslinker, and
an aqueous carrier;
applying the coating composition on at least a portion of the glass substrate; and
curing the coating composition to produce a cured coating;
wherein, when applied on a surface of a flat glass substrate and cured to yield a coating having dry film thickness of 0.0013 millimeters, the coating composition exhibits a taber abrasion resistance of at least 100 cycles when tested pursuant to ASTM D4060-01 using a single CS-10F calibrase wheel as the abrasive wheel.
